(19) United States
(12) Patent Application Publication
(10) Pub. No.: US 2015/0026813 A1
(43) Pub. Date: Jan. 22, 2015

(54) METHOD AND SYSTEM FOR DETECTING NETWORK LINK

(71) Applicant: TENCENT TECHNOLOGY (SHENZHEN) COMPANY LIMITED, Shenzhen City (CN)

(72) Inventors: Youngfeng WANG, Shenzhen City (CN); Huashang LIN, Shenzhen City (CN); Chen WEN, Shenzhen City (CN)

(21) Appl. No.: 14/510,776

(22) Filed: Oct. 9, 2014

Related U.S. Application Data
(63) Continuation of application No. PCT/CN2013/089791, filed on Dec. 18, 2013.

(30) Foreign Application Priority Data
Feb. 26, 2013 (CN) 201310060374.8

(51) Int. Cl. H04L 29/06; H04L 29/08

(52) U.S. Cl. CPC H04L 63/1433; H04L 63/1408; H04L 67/22
USPC 726/25

(57) ABSTRACT

A method and system for detecting network link are disclosed. The method includes: receiving copy content by capturing a copy behavior; performing malware detection on network link in the copy content to obtain a detection result; generating a risk warning message according to the detection result. The system includes: a receiving module, configured to receive copy content by capturing a copy behavior; a detecting module, configured to perform malware detection on network link in the copy content to obtain a detection result; a message generating module, configured to generate a risk warning message according to the detection result. The method and system can reduce the attack risk of malicious network link.

### CROSS REFERENCE TO RELATED APPLICATION

This application is a continuation application of the PCT International Application No. PCT/CN2013/089791, filed on Dec. 18, 2013, entitled “METHOD AND SYSTEM FOR DETECTING NETWORK LINK” by Yongfeng WANG, Huashang LIN and Chen WEN, which claims the priority from the Chinese patent application No. CN 201310060374.8, filed on Feb. 26, 2013. The above-referenced applications are hereby incorporated herein in their entireties by reference.

### FIELD OF THE INVENTION

The present disclosure relates to the field of internet security technology, and more particularly, to a method and system for detecting network link.

### BACKGROUND OF THE INVENTION

With the development of internet, it becomes more and more frequent that people access the internet via network link, to obtain required information and services. For example, a user can access an email box via internet, browse the received email in email box interface, and click on a network link provided in the email to enter a web page mentioned in the email.

When the user clicks on a network link, the network link will be detected to judge whether the network link is a malicious link, and then a prompt page is popped up to remind the user. However, in practical application, because it is not possible to detect the network link when the user copies and opens the network link, there is a high attack risk of malicious link.

### SUMMARY OF THE INVENTION

In view of the above, it is necessary to provide a method for detecting network link to reduce the attack risk of malicious network link.

In addition, it is also necessary to provide a system for detecting network link to reduce the attack risk of malicious network link.

According to one aspect of the disclosure, a method for detecting network link includes:
receiving copy content by capturing a copy behavior;
performing malware detection on network link in the copy content to obtain a detection result;
generating a risk warning message according to the detection result.

According to another aspect of the disclosure, a terminal for detecting network link, wherein the terminal including a device which includes:
a receiving module, configured to receive copy content by capturing a copy behavior;
a detecting module, configured to perform malware detection on network link in the copy content to obtain a detection result;
a message generating module, configured to generate a risk warning message according to the detection result.

According to still a further aspect of the disclosure, a non-transitory computer-readable storage medium including an executable program to execute a method for detecting network link is disclosed, wherein the method including:
receiving copy content by capturing a copy behavior;
performing malware detection on network link in the copy content to obtain a detection result;
generating a risk warning message according to the detection result.

The method and system for detecting network link receive the copy content generated by the copy behavior to perform malware detection on the network link in the copy content, and generate a risk warning message according to the detection result obtained by malicious detection, thereby achieving that when the user copies a network link, a malware detection is immediately performed on the network link, which avoids a fraud generated by opening a malicious link through the network link, and reduces the attack risk of malicious network link.

### BRIEF DESCRIPTION OF DRAWINGS

FIG. 1 is a flowchart illustrating a method for detecting network link according to one embodiment of the present disclosure;

FIG. 2 is a timing diagram illustrating a method for detecting network link according to one embodiment of the present disclosure;

FIG. 3 is an interface diagram illustrating a method for detecting network link according to one embodiment of the present disclosure;

FIG. 4 is a schematic diagram illustrating a structure of a system for detecting network link according to one embodiment of the present disclosure;

FIG. 5 is a schematic diagram illustrating a structure of a system for detecting network link according to another embodiment of the present disclosure;

FIG. 6 is a schematic diagram illustrating a structure of a detecting module according to one embodiment of the present disclosure;

FIG. 7 is a schematic diagram illustrating a structure of a system for detecting network link according to another embodiment of the present disclosure.

FIG. 8 depicts an exemplary computing system consistent with the disclosed embodiments.

### DETAILED DESCRIPTION OF THE INVENTION

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 8 shows a block diagram of an exemplary computing system 700 (or computer system 700) capable of implementing a terminal which includes the device as illustrated in FIGS. 4, 5 and 7 as described below. The terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other client-side computing device. As shown in FIG. 8, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, e.g., Read-Only Memory (ROM), Random Access Memory (RAM), and flash memory modules, and mass storages, e.g., CD-ROM, U-disk, removable hard disk, etc. The storage medium 704 may store computer programs for implementing various processes, when executed by the processor 702.

The monitor 706 may include display devices for displaying contents in the computing system 700. The peripherals 712 may include I/O devices such as keyboard and mouse.

Further, the communication module 708 may include network devices for establishing connections through a communication network. The database 710 may include one or more databases for storing certain data and for performing certain operations on the stored data.

The methods and systems disclosed in accordance with various embodiments can be executed by a computer system. In one embodiment, the disclosed methods and systems can also be implemented by a server.

Various embodiments provide methods and systems for detecting network link. The methods and systems are illustrated in various examples described herein.

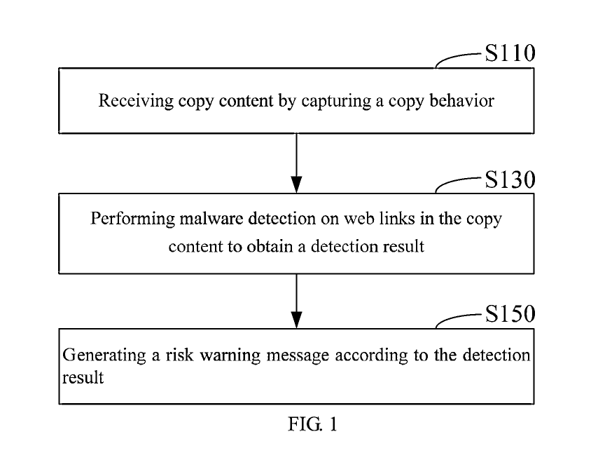

As illustrated in FIG. 1, in one embodiment of the present disclosure, a method for detecting network link, includes the following steps:

Step S110, receiving copy content by capturing a copy behavior.

In this embodiment, the copy content is a copy object in a page when the user triggers copy behavior, and the copy content can include text messages, picture messages and network link, etc.

In one embodiment, before the step of S110, the method further includes: capturing the copy behavior in a page, obtaining the copy content according to the copy behavior, and reporting the copy content.

In the embodiment, the copy behavior triggered in current displayed page is captured to obtain the copy content corresponding to the copy behavior, and the copy content is reported to backend server.

Step S130, performing malware detection on the network link in the copy content to obtain a detection result.

In the embodiment, after receiving the copy content reported, it will be detected that whether the network link in the copy content is a malicious network link and corresponding detection result is generated. When the copy content includes several network links, malware detections will be performed on the network links one by one. At this time, the detection result obtained will individually identify which network link is a malicious network link, and which network link is a secure network link.

In one embodiment, the above step S130 includes: judging whether a network link is existed in the copy content, if yes, then extracting the network link from the copy content, and performing malware detection on the network link, and returning a detection result; if no, then ending.

In the embodiment, after receiving the copy content reported by the current displayed page, it will be determined that whether a network link is existed in the copy content copied by the user, if yes, then it is needed to perform malware detection on the network link existed in the copy content, and if the network link are not existed in the copy content, then all the processes are to be ended.

Furthermore, a number of malicious network links and fields contained in the malicious network link are pre-stored, and then check according to the network link extracted from the copy content, judge whether the network link is the malicious network link pre-stored, or whether the network link contains the fields pre-stored, if yes, it indicates the network link is the malicious network link, generating a detection result identifying the network link is a malicious network link, if no, it indicates that the network link is a relatively secure network link.

Step S150, generating a risk warning message according to the detection result.

In the embodiment, a risk warning message is generated for the network link which is identified as the malicious network link, to prompt the user that current copied network link has risk, and the user is suggested stop access to the web address.

In one embodiment, the above step S150 includes: judging whether the network link is the malicious network link according to the detection result returned, if yes, then generating a risk warning message, if no, then ending.

In the embodiment, the detection result returned is read, and it is judged that whether the network link is identified as the malicious network link in the detection result, and if yes, a risk warning message for the network link is generated, to targeted reminder the network link in the copy content, and if no, nothing is to be done.

In one embodiment, before the above step S150, it further includes a step of obtaining a user identification of a user triggering the copy behavior.

In the embodiment, when the trigged copy behavior is captured, the user identification logged in current page is also obtained, and the user identification is the user identification which trigged the copy behavior. For example, in the e-mail browse page of the email box, an account logged in the email box is the user identification of the user triggering the copy behavior.

In another embodiment, after the step S150, it further includes: returning the risk warning message according to the user identification, and displaying the same in the page where the user identification is.

In the embodiment, the risk warning message generated is returned to the page where the obtained user identification is, and the risk warning message is displayed in the page. For example, a prompt floating layer will be popped up next to corresponding network link in the page, and the risk warning messages are displayed in the prompt floating layer.

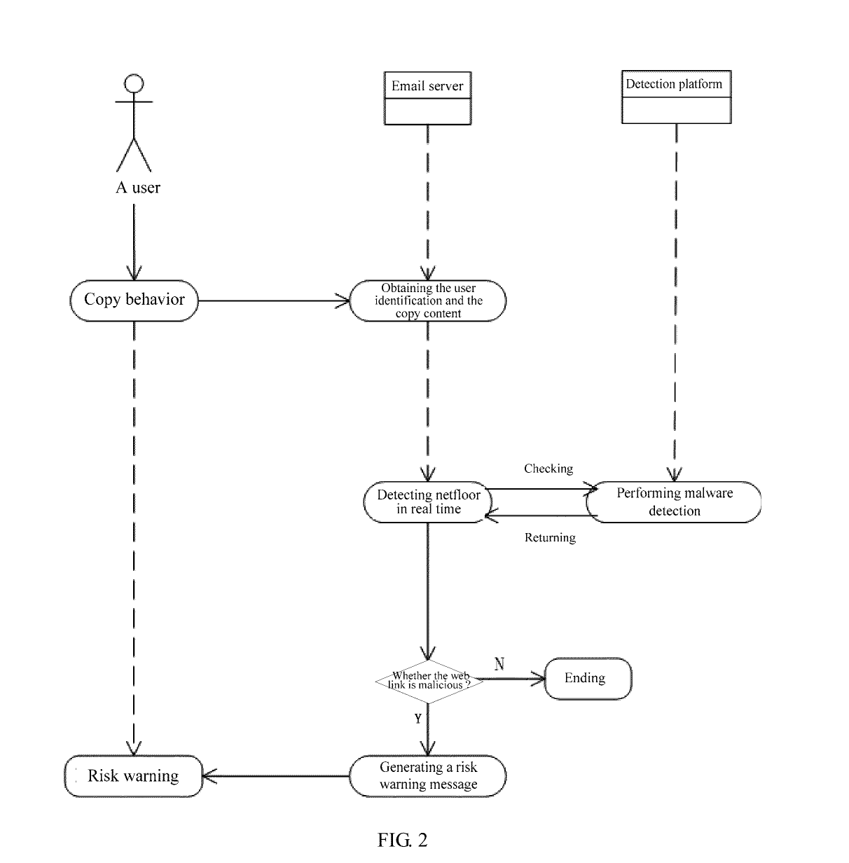

The method for detecting network link will be described below combined with one particular embodiment. In the embodiment, a email box is as an application scene, and when the user browses one email received by the email box, the user triggers the copy behavior in the email page, as illustrated in FIG. 2. At this time, the copy behavior triggered in the email page is captured, and the copy content is obtained according to the copy behavior, and the account currently logged in the email box and the copy content are reported to a backend email server.

After the email server receives the account for logging in the email box and the copy content, a malware detection is performed on the network link in the copy content in real time, and it is checked in a detection platform that whether the network link is a malicious network link, if yes, then a detection result which identified that the network link is the malicious network link is returned.

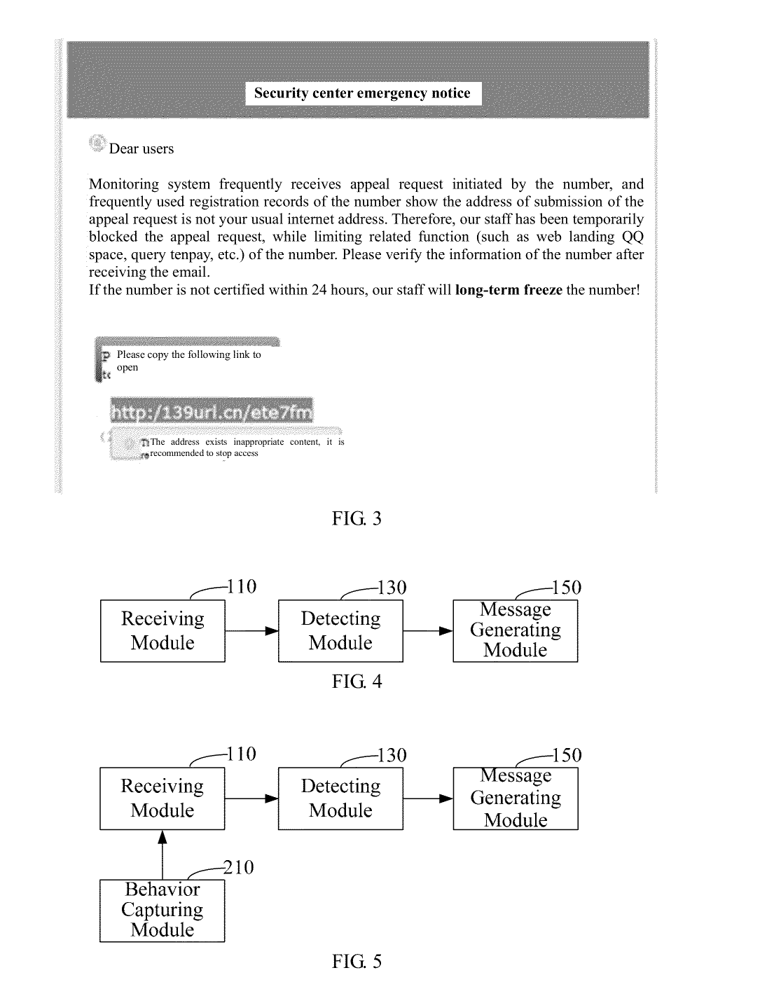

The email server reads the returned detection result, then it can be determined according to the detection result that which network link in the copy content is a malicious network link. The risk warning message is generated for the network link which is determined as a malicious network link, and according to the account for logging in the email box, the risk warning message is displayed in the email page in which the copy behavior is triggered, as illustrated in FIG. 3. A risk warning is performed for the copy content which is determined as a malicious network link, informing the user that there is risk in the current copied network link.

As illustrated in FIG. 4, in one embodiment, a system for detecting network link, includes a receiving module 110, a detecting module 130, and a message generating module 150.

A receiving module 110 is configured to receive the copy content by capturing a copy behavior.

In the embodiment, the copy content is a copy object in a page when the user triggers copy behavior, and the copy content may includes text messages, picture messages and network links, etc.

As illustrated in FIG. 5, in one embodiment, the system for detecting network link further includes a behavior capturing module 210. The behavior capturing module 210 is configured to capture the copy behavior in a page, and according to the copy content obtained by the copy behavior, report the copy content.

In the embodiment, the behavior capturing module 210 captures the copy behavior triggered in current displayed page, to obtain the copy content corresponding to the copy behavior, and reports the same to the receiving module 110 in a backend server. The behavior capturing module 210 can be a plug-in provided in the page.

A detecting module 130 is configured to perform malware detection on a network link in the copy content to obtain the detection result.

In the embodiment, after receiving the copy content reported, the detecting module 130 detects whether a network link in the copy content is a malicious network link, and generates corresponding detection result. When the copy content includes several network links, the detecting module 130 perform malware detections on the network links one by one. At this time, the detection result obtained will individually identifies which network link is a malicious network link, and which network link is a secure network link.

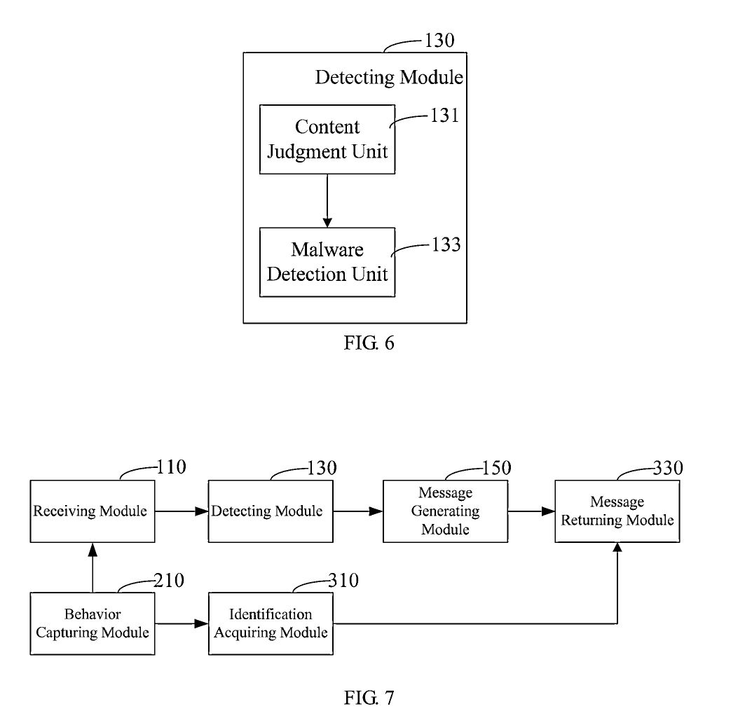

As illustrated in FIG. 6, in one embodiment, the detecting module 130 includes a content judgment unit 131 and a malware detection unit 133.

The content judgment unit 131 is configured to judge whether a network link is existed in the copy content, if yes, then informing the malware detection unit 133, if no, then ending;

In the embodiment, after receiving the copy content reported by the current displayed page, the content judgment unit 131 determines whether a network link is existed in the copy content copied by the user, if yes, then it is necessary for the content judgment unit 131 to perform a malware detection on the network link existed in the copy content, if no network link is existed in the copy content, then all the processes are to be ended.

The malicious detection unit 133 is configured to extract a network link from the copy content, perform a malware detection on the network link, and then return a detection result.

In the embodiment, a number of malicious network link and fields contained in the malicious network link are pre-stored, and then the malicious detection unit 133 checks according to the network link extracted from the copy content, and judges whether the network link is a malicious network link pre-stored, or whether the network link contains the fields pre-stored, if yes, then it indicates that the network link is a malicious network link and a detection result identifying the network link is a malicious network link is generated, if no, then it indicates that the network link is a relatively secure network link.

The message generating module 150 is configured to generate a risk warning message according to the detection result.

In the embodiment, the generating module 150 generates a risk warning message for the network link which is identified as a malicious network link in the detection result, so as to prompt the user that the current network link copied has risk, and suggests the user stop accessing the web address.

In one embodiment, the message generating module 150 is also configured to judge whether the network link is a malicious network link according to the detection result returned, and if yes, generates a risk warning message, if no, ending the step.

In the embodiment, the message generating module 150 reads the detection result returned, and judges whether the network link is identified as a malicious network link in the detection result, if yes, generates a risk warning message for the network link, to targeted reminder the network link in the copy content, if no, nothing is to be done.

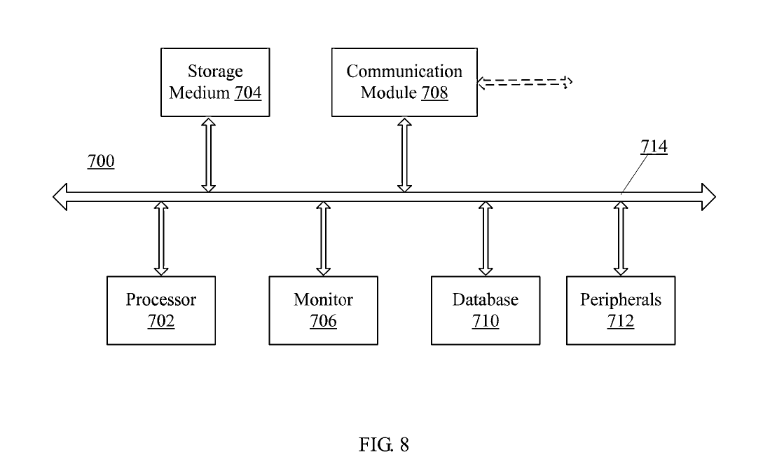

As illustrated in FIG. 7, in another embodiment, the system for detecting network link further includes an identification acquiring module 310 and a message returning module 330.

The identification acquiring module 310 is configured to capture a user identification of a user triggering the copy behavior.

In the embodiment, when the trigged copy behavior is captured, the identification acquiring module 310 also acquires the user identification logged in current page, and the user identification is the user identification which trigged the copy behavior. For example, in the e-mail messages browse page, an account logged in the email box is the user identification of the user triggering the copy behavior.

The message returning module 330 is configured to return the risk warning message according to the user identification, and display the same in a page where the user identification is.

In the embodiment, the message returning module 330 returns the generated risk warning message to the page where the user identification obtained is, and displays the same in the page. For example, a prompt floating layer will be popped up next to corresponding network link in the page, and the risk warning message is displayed in the prompt floating layer.

The method and system for detecting network link receive the copy content generated by the copy behavior to perform a malware detection on a network link in the copy content, and generate a risk warning message according to the detection result obtained by the malware detection, thereby achieving that when the user copies a network link, a malware detection is immediately performed on the network link, which avoids a fraud generated by opening a malicious link through the network link, and reduces the attack risk of malicious network link.

A person skilled in the art will understand that the performance of all or part of the process of the method in the embodiments can be achieved by a computer program to instruct relevant hardware. The computer program can be stored in a computer-readable storage medium. When the computer program is implemented, it can include the process of the methods according to the embodiments. Wherein the storage medium may be a magnetic disk, optical disk, read only memory (ROM), or random access memory (RAM) and so on.

The foregoing are only several embodiments of the present disclosure, of which the description are more specific and detailed, but it cannot therefore be understood as limiting the scope of the present disclosure. It should be noted that, for a person skilled in the art, without departing from the inventive concept, a number of variations and modifications may be made, which are part of the scope of the present disclosure. Accordingly, the protection scope of the present disclosure is according to the appended claims.

What is claimed is:

1. A method for detecting network link, comprising:
receiving copy content by capturing a copy behavior;
performing malware detection on network link in the copy content to obtain a detection result;
generating a risk warning message according to the detection result.

2. The method according to claim 1, wherein the step of performing malware detection on network link in the copy content to obtain a detection result comprises:
judging whether a network link is existed in the copy content, if yes, then
extracting the network link from the copy content, and performing malware detection on the network link, and returning the detection result.

3. The method according to claim 1, wherein the step of generating a risk warning message according to the detection result comprises:
judging whether the network link is a malicious network link, if yes, generating a risk warning message.

4. The method according to claim 1, wherein before the step of receiving copy content by capturing a copy behavior, the method further comprises:
capturing a copy behavior in a page, obtaining copy content according to the copy behavior, and reporting the copy content.

5. The method according to claim 1, wherein the method further comprises:
before the step of generating a risk warning message according to the detection result, obtaining a user identification of a user triggering the copy behavior; and
after the step of generating a risk warning message according to the detection result, returning a risk warning message according to the user identification, and displaying the risk warning message in a page where the user identification is.

6. A terminal for detecting network link, wherein the terminal including a device which comprises:
a receiving module, configured to receive copy content by capturing a copy behavior;
a detecting module, configured to perform malware detection on network link in the copy content to obtain a detection result;
a message generating module, configured to generate a risk warning message according to the detection result.

7. The terminal according to claim 6, wherein the detecting module comprises:
a content judgment unit, configured to judge whether a network link is existed in the copy content, if yes, informing a malware detection unit;
the malware detection unit is configured to extract the network link from the copy content, perform malware detection on the network link, and return a detection result.

8. The terminal according to claim 6, wherein the message generating module is also configured to judge whether the network link is a malicious network link according to the returned detection result, if yes, generating a risk warning message.

9. The terminal according to claim 6, wherein it further comprises:
a behavior capturing module, configured to capture the copy behavior in a page, obtain the copy content according to the copy behavior, and report the copy content.

10. The terminal according to claim 6, wherein it further comprises:
an identification acquiring module, configured to acquire a user identification of a user triggering the copy behavior;
a message returning module, configured to return a risk warning message according to the user identification, and display the risk warning message in a page where the user identification is.

11. A non-transitory computer-readable storage medium comprising an executable program to execute a method for detecting network link, the method comprising:
receiving copy content by capturing a copy behavior;
performing malware detection on network link in the copy content to obtain a detection result;
generating a risk warning message according to the detection result.

12. The non-transitory computer-readable storage medium of claim 11, wherein the step of performing malware detection on network link in the copy content to obtain a detection result comprises:
judging whether a network link is existed in the copy content, if yes, then
extracting the network link from the copy content, and performing malware detection on the network link, and then returning a detection result.

13. The non-transitory computer-readable storage medium of claim 11, wherein the step of generating a risk warning message according to the detection result comprises:
judging whether the network link is a malicious network link, if yes, generating a risk warning message.

14. The non-transitory computer-readable storage medium of claim 11, wherein before the step of receiving copy content by capturing a copy behavior, the method further comprises:
capturing copy behavior in a page, obtaining copy content according to the copy behavior, and reporting the copy content.

15. The non-transitory computer-readable storage medium of claim 11, wherein the method further comprises:
before the step of generating a risk warning message according to the detection result, obtaining a user identification of a user triggering the copy behavior; and
after the step of generating a risk warning message according to the detection result, returning a risk warning message according to the user identification, and displaying the risk warning message in a page where the user identification is.
